(19) United States
(12) Patent Application Publication
(10) Pub. No.: US 2022/0318753 A1
(43) Pub. Date: Oct. 6, 2022

(54) SYSTEM AND METHOD FOR PERFORMING ANALYSIS AND GENERATING REMEDIATION ESTIMATIONS FOR USER INTERFACES ASSOCIATED WITH SOFTWARE APPLICATIONS

(71) Applicant: BANK OF AMERICA CORPORATION, Charlotte, NC (US)

(72) Inventors: Michael Ogrinz, Easton, CT (US); Allison Baker, Charlotte, NC (US); Jeremiah Fellows, Centennial, CO (US); Gerard P. Gay, Seattle, WA (US); Mark Odiorne, Waxhaw, NC (US); Regina Peyfuss, Denver, CO (US); Susan Teague Rector, Denver, CO (US); Siddhesh V. Wadikar, Denver, CO (US)

(73) Assignee: BANK OF AMERICA CORPORATION, Charlotte, NC (US)

(21) Appl. No.: 17/217,948

(22) Filed: Mar. 30, 2021

(51) Int. Cl. G06Q 10/10; G06N 20/00; G06F 8/38; G06Q 10/06; G06F 8/77

(52) U.S. Cl. CPC G06Q 10/103; G06N 20/00; G06F 8/38; G06Q 10/06314; G06F 8/77

(57) ABSTRACT

Embodiments of the present invention provide a system for performing analysis and generating remediation estimations for user interfaces associated with software applications. The system is configured for crawling one or more software applications associated with an entity, identifying one or more user interface elements associated with the one or more software applications, comparing and analyzing the one or more user interface elements with one or more standards stored in a data repository, and generating one or more remediation estimations associated with modifying the one or more user interface elements to meet the one or more standards based on comparing and analyzing the one or more user interface elements with the one or more standards.

### BACKGROUND

Conventional systems do not have the ability to perform analysis and generate remediation estimations associated with any alterations that are being implemented within an entity. As such, there exists a need for a system to perform analysis and generate estimations for user interfaces associated with software applications of an entity.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for performing analysis and generating remediation estimations for user interfaces associated with software applications. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention crawls one or more software applications associated with an entity, identifies one or more user interface elements associated with the one or more software applications, compares and analyzes the one or more user interface elements with one or more standards stored in a data repository, and generates one or more remediation estimations associated with modifying the one or more user interface elements to meet the one or more standards based on comparing and analyzing the one or more user interface elements with the one or more standards.

In some embodiments, the present invention starts crawling the one or more software applications in response to receiving a new alteration from an entity system, wherein the one or more standards comprise new alteration standards associated with the new alteration.

In some embodiments, the present invention calculates a deviation score for each of the one or more user interface elements based on the one or more standards, wherein the deviation score is used to generate the one or more remediation estimations.

In some embodiments, the present invention monitors one or more software development projects, via one or more machine learning models, collects data associated with the one or more software development projects, generates one or more time estimations associated with development of one or more user interface features associated with the one or more software development projects, wherein the one or more user interface elements are similar to the one or more user interface features, and generates the one or more remediation estimations based on the one or more time estimations.

In some embodiments, the one or more remediation estimations are generated based on user input.

In some embodiments, the one or more remediation estimations are generated based on accessing records associated with users from a project tracking application.

In some embodiments, the present invention constantly scans the one or more software applications to determine one or more updates to the one or more software applications and generates new set of remediation estimations associated with the one or more updates.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for performing analysis and generating remediation estimations for user interfaces associated with software applications of an entity, in accordance with an embodiment of the invention;

FIG. 2 provides a block diagram illustrating the entity system 200 of FIG. 1, in accordance with an embodiment of the invention;

FIG. 3 provides a block diagram illustrating a remediation estimation system 300 of FIG. 1, in accordance with an embodiment of the invention;

FIG. 4 provides a block diagram illustrating the computing device system 400 of FIG. 1, in accordance with an embodiment of the invention; and

FIG. 5 provides a flowchart illustrating a process flow for performing analysis and generating remediation estimations for user interfaces associated with software applications of an entity, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the term “entity” may include any organization that processes financial transactions including, but not limited to, banks, credit unions, savings and loan associations, investment companies, stock brokerages, insurance companies and the like. In accordance with some embodiments of the invention, the term “entity” may include any organization that creates, manages, maintains, and/or utilizes one or more software applications to perform one or more organizational activities. Furthermore, embodiments of the present invention use the term “user.” The term “user” may represent an employee of the entity.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

Typically there may be ‘n’ number of software applications utilized by an entity to perform one or more organizational activities and each of the software applications must adhere to certain standards and guidelines set by the entity and/or a compliance agency. However, all software applications within the entity may not completely adhere to the standards and guidelines, thereby causing uncertainty and creating a chance of exposure, where bad actors may use this as an opportunity to gain access to unauthorized data (e.g., user credentials) by creating a replica of the software applications, or the like. Additionally, if there is an alteration associated with an entity that may be caused by internal changes (e.g., entity brand changes) and/or compliance changes, the software applications of the entity need to be modified to adhere to the new alterations. Conventional systems do not have the ability to perform analysis and generate remediation estimations associated with the new alterations and/or converting all the software applications within an entity to adhere to the standards and guidelines. As such, there exists a need for a system to perform analysis and generate remediation estimations for user interfaces associated with software applications. Additionally the present invention may also generate remediation estimations associated with converting a web based application to a mobile application.

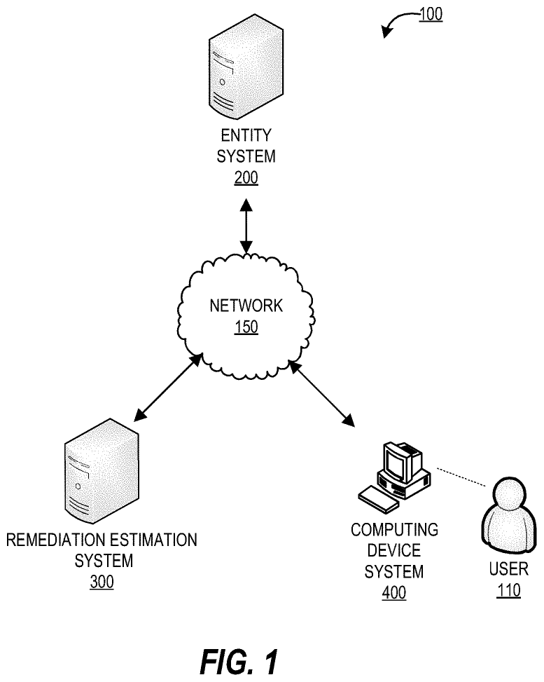

FIG. 1 provides a block diagram illustrating a system environment 100 for performing analysis and generating remediation estimations for user interfaces associated with software applications, in accordance with an embodiment of the invention. As illustrated in FIG. 1, the environment 100 includes a remediation estimation system 300, entity system 200, and/or a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees of an entity associated with the entity system 200.

The entity system(s) 200 may be any system owned or otherwise controlled by an entity to support or perform one or more process steps described herein. In some embodiments, the managing entity is a financial institution. In some embodiments, the managing entity may be a non-financial institution. In some embodiments, the entity system 200 may include one or more servers. In some embodiments, the managing entity may be any organization that creates, manages, maintains, and/or utilizes one or more software applications to perform one or more organizational activities.

The remediation estimation system 300 is a system of the present invention for performing one or more process steps described herein. In some embodiments, the remediation estimation system 300 may be an independent system. In some embodiments, the remediation estimation system 300 may be a part of the entity system 200.

The remediation estimation system 300, the entity system 200, and/or the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the remediation estimation system 300 is configured to communicate information or instructions with the entity system 200, and/or the computing device system 400 across the network 150.

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the remediation estimation system 300, and/or entity system 200 across the network 150.

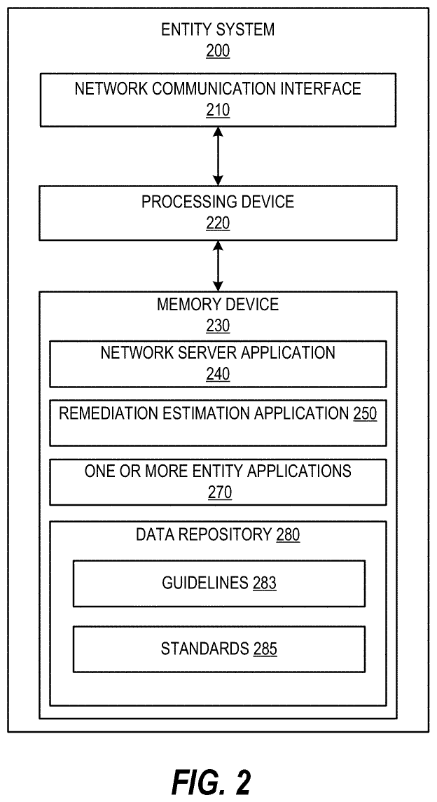

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a remediation estimation application 250, one or more entity applications 270, and a data repository 280 comprising at least guidelines 283 and standards 285. The guidelines 283 and standards 285 may be set by the entity and/or a compliance agency. In some embodiments, the guidelines 283 and standards 285 may be associated with one or more user interface elements (e.g., page layout, graphical elements, styling elements, iconography, widgets, or the like) associated with one or more software applications of the entity. The computer-executable program code of the network server application 240, the remediation estimation application 250, the one or more entity applications 270, to perform certain logic, data-extraction, and data-storing functions of the entity system 200 described herein, as well as communication functions of the entity system 200.

The network server application 240, the remediation estimation application 250, the one or more entity applications 270, are configured to store data in the data repository 280 or to use the data stored in the data repository 280 when communicating through the network communication interface 210 with the remediation estimation system 300, and/or the computing device system 400 to perform one or more process steps described herein. In some embodiments, the entity system 200 may receive instructions from the remediation estimation system 300 via the remediation estimation application 250 to perform certain operations. The remediation estimation application 250 may be provided by the remediation estimation system 300. The one or more entity applications 270 may be any of the applications used, created, modified, and/or managed by the entity system 200.

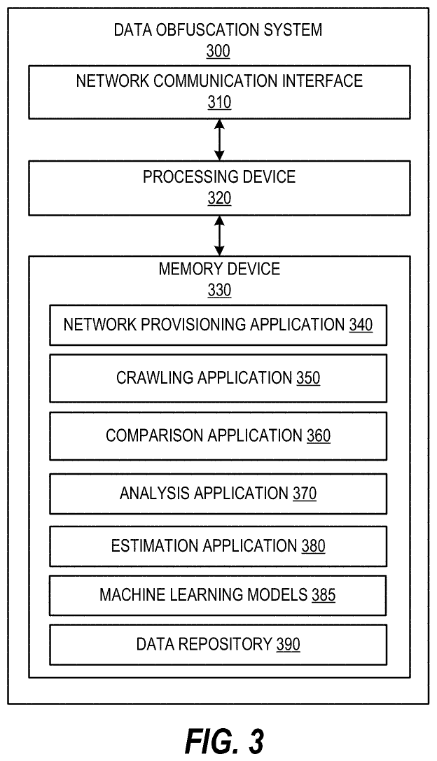

FIG. 3 provides a block diagram illustrating the remediation estimation system 300 in greater detail, in accordance with embodiments of the invention. As illustrated in FIG. 3, in one embodiment of the invention, the remediation estimation system 300 includes one or more processing devices 320 operatively coupled to a network communication interface 310 and a memory device 330. In certain embodiments, the remediation estimation system 300 is operated by a first entity, such as a financial institution, while in other embodiments, the remediation estimation system 300 is operated by an entity other than a financial institution. In some embodiments, the remediation estimation system 300 is owned or operated by the entity of the entity system 200. In some embodiments, the remediation estimation system 300 may be an independent system. In alternate embodiments, the remediation estimation system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the remediation estimation system 300 described herein. For example, in one embodiment of the remediation estimation system 300, the memory device 330 includes, but is not limited to, a network provisioning application 340, a crawling application 350, a comparison application 360, an analysis application 370, an estimation application 380, one or more machine learning models 385, and a data repository 390 comprising data processed or accessed by one or more applications in the memory device 330. The computer-executable program code of the network provisioning application 340, the crawling application 350, the comparison application 360, the analysis application 370, the estimation application 380, and the one or more machine learning models 385 may instruct the processing device 320 to perform certain logic, data-processing, and data-storing functions of the remediation estimation system 300 described herein, as well as communication functions of the remediation estimation system 300.

The network provisioning application 340, the crawling application 350, the comparison application 360, the analysis application 370, the estimation application 380, and the one or more machine learning models 385 are configured to invoke or use the data in the data repository 390 when communicating through the network communication interface 310 with the entity system 200, and/or the computing device system 400. In some embodiments, the network provisioning application 340, the crawling application 350, the comparison application 360, the analysis application 370, the estimation application 380, and the one or more machine learning models 385 may store the data extracted or received from the entity system 200, and the computing device system 400 in the data repository 390. In some embodiments, the network provisioning application 340, the crawling application 350, the comparison application 360, the analysis application 370, the estimation application 380, and the one or more machine learning models 385 may be a part of a single application.

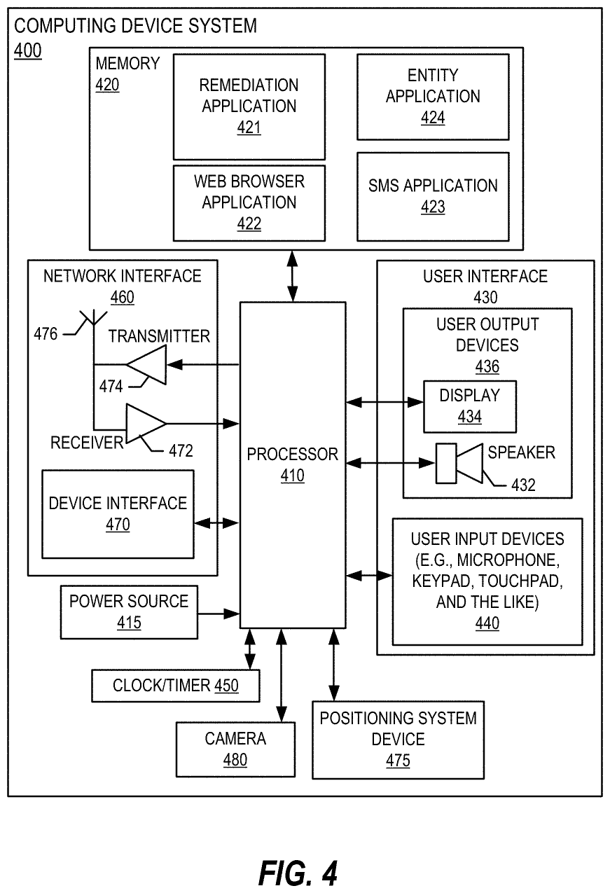

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a remediation estimation application 421, entity application 424. These applications also typically instructions to a graphical user interface (GUI) on the display 430 that allows the user 110 to interact with the entity system 200, the remediation estimation system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the remediation estimation application 421 provided by the remediation estimation system 300 allows the user 110 to access the remediation estimation system 300. In some embodiments, the entity application 424 may be provided by the entity system 200. In some embodiments, the remediation estimation application 421 allow the user 110 to access the functionalities provided by the remediation estimation system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

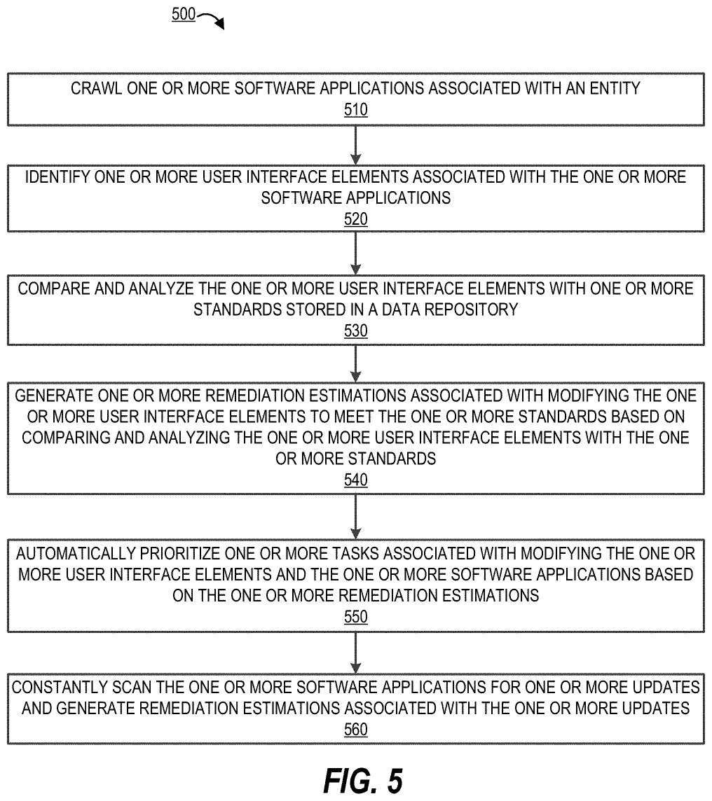

FIG. 5 provides a flowchart illustrating a process flow for performing analysis and generating remediation estimations for user interfaces associated with software applications, in accordance with an embodiment of the invention.

As shown in block 510, the system crawls one or more software applications associated with an entity. The system may use an intelligent web crawler to crawl the one or more software applications. In some embodiments, the one or more software applications may be web based applications. In some embodiments, the one or more software applications may be mobile applications. In some embodiments, the one or more software applications may be applications that are accessed and/or used by users (e.g., employees) of the entity. In some embodiments, the one or more software applications may be applications that are accessed and/or used by customers of the entity.

As shown in block 520, the system identifies one or more user interface elements associated with the one or more software applications. The one or more user interface elements may include, but are not limited to, typography elements, iconography elements (e.g., brand, logo, mascot, or the like), graphical elements, widgets, and/or the like. The one or more user interface elements may be any elements that provide accessibility and experience when a user and/or customer is accessing the one or more software applications. In other words, interactions of the user and/or customers with the one or more software applications is driven by the one or more user interface elements.

As shown in block 530, the system compares and analyzes the one or more user interface elements with one or more standards stored in a data repository. The one or more standards may comprise rules, guidelines, or the like that define the user interface of the one or more software applications. In some embodiments, the one or more standards are set by the entity. In some embodiments, the one or more standards are set by a compliance agency. In some embodiments, the one or more standards are set by both the entity and the compliance agency. Comparing and analyzing the one or more user interface elements comprises calculating a deviation score for each of the one or more user interface elements based on the one or more standards. For example, the system may determine that a widget is completely different from the one or more standards and may calculate the deviation score as 80%.

As shown in block 540, the system generates one or more remediation estimations associated with modifying the one or more user interface elements to meet the one or more standards based on comparing and analyzing the one or more user interface elements with the one or more standards. The one or more remediation estimations may comprise time estimations, cost estimations, and value estimations associated with modification of the one or more user interface elements to meet the one or more standards.

Generation of the one or more remediation estimations may be based on the deviation score, time estimations collected by the system via one or more machine learning models, user input, one or more records associated with users from a project tracking application, or the like. In some embodiments, the system may track one or more software development projects, via the one or more machine learning models and collects data associated with the one or more software development projects. The system may then identify one or more user interface features in the one or more software development projects that are similar to the user interface elements identified in block 520 and may calculate one or more time estimations associated with the development of the one or more user interface features based on the collected data. The system may then use the one or more time estimations to generate the one or more remediation estimations. In some embodiments, the system may prompt one or more users to provide the user input associated with modification of the one or more user interface elements to meet the one or more standards. For example, the system may prompt the user to provide an estimated time to complete a medication/task associated with a user interface element. In some embodiments, the system may access a project tracking application which comprises one or more time records/entries provided by the users, where the time entries are associated with development/modification of user interface features from other software development projects that are similar to the user interface elements identified in 520.

In some embodiments, the system may perform the process flow described in block 510 through block 550 to allow a user to take decisions associated with updating the one or more software applications such that they adhere to the one or more standards set by the entity and/or the compliance agency.

In some embodiments, the system may initiate the process flow at block 510 after receiving a new alteration from the entity system. For example, the entity may decide to re-brand or change entity's logo. In such a case, the system may receive the new alteration from the entity system and may store the standards (e.g., rules, guidelines, etc.) in the data repository. In some embodiments, the new alteration may be associated with a new regulation introduced by a compliance agency.

As shown in block 550, the system automatically prioritizes one or more tasks associated with modifying the one or more user interface elements and the one or more software applications based on the one or more remediation estimations. The system may prioritize the one or more tasks based on the value provided by the one or more tasks, time estimations, and cost estimations. For example, the system may determine that (i) performing a first task may cost $ZZ.ZZ and take HH:HH time and may provide 70% compliance and (ii) performing a second task may cost $XX.XX and take YY:YY time and may provide 80% compliance, where $ZZ.ZZ and HH:HH are greater than $XX.XX and YY:YY respectively. Based on the estimations, the system may prioritize the second task. In some embodiments, the prioritization may be based on at least one of type of application, value, compliance, business importance, business rules, and/or the like.

As shown in block 560, the system constantly scans the one or more software applications for one or more updates and generate remediation estimations associated with the one or more updates. The system of the present invention may also provide estimations associated with developing a mobile application based on a web based application. In some embodiments, the present invention may also automatically calculate efficiency score as a byproduct of performing the steps described in process flow 500.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for performing analysis and generating remediation estimations for user interfaces associated with software applications, the system comprising:
at least one network communication interface;
at least one non-transitory storage device; and
at least one processing device coupled to the at least one non-transitory storage device and the at least one network communication interface, wherein the at least one processing device is configured to:
crawl one or more software applications associated with an entity;
identify one or more user interface elements associated with the one or more software applications;
compare and analyze the one or more user interface elements with one or more standards stored in a data repository; and
generate one or more remediation estimations associated with modifying the one or more user interface elements to meet the one or more standards based on comparing and analyzing the one or more user interface elements with the one or more standards.

2. The system of claim 1, wherein the at least one processing device is configured to start crawling the one or more software applications in response to:
receiving a new alteration from an entity system, wherein the one or more standards comprise new alteration standards associated with the new alteration.

3. The system of claim 1, wherein comparing and analyzing the one or more user interface elements further comprises:
calculating a deviation score for each of the one or more user interface elements based on the one or more standards, wherein the deviation score is used to generate the one or more remediation estimations.

4. The system of claim 1, wherein the at least one processing device is configured to:
monitor one or more software development projects, via one or more machine learning models;
collect data associated with the one or more software development projects;
generate one or more time estimations associated with development of one or more user interface features associated with the one or more software development projects, wherein the one or more user interface elements are similar to the one or more user interface features; and
generate the one or more remediation estimations based on the one or more time estimations.

5. The system of claim 1, wherein the one or more remediation estimations are generated based on user input.

6. The system of claim 1, wherein the one or more remediation estimations are generated based on accessing records associated with users from a project tracking application.

7. The system of claim 1, wherein the at least one processing device is configured to:
constantly scan the one or more software applications to determine one or more updates to the one or more software applications; and
generate new set of remediation estimations associated with the one or more updates.

8. A computer program product for performing analysis and generating remediation estimations for user interfaces associated with software applications, the computer program product comprising a non-transitory computer-readable storage medium having computer executable instructions for causing a computer processor to perform the steps of:
crawling one or more software applications associated with an entity;
identifying one or more user interface elements associated with the one or more software applications;
comparing and analyzing the one or more user interface elements with one or more standards stored in a data repository; and
generating one or more remediation estimations associated with modifying the one or more user interface elements to meet the one or more standards based on comparing and analyzing the one or more user interface elements with the one or more standards.

9. The computer program product of claim 8, wherein the computer executable instructions computer executable instructions cause a computer processor to perform the steps of crawling the one or more software applications in response to:
receiving a new alteration from an entity system, wherein the one or more standards comprise new alteration standards associated with the new alteration.

10. The computer program product of claim 8, wherein the computer executable instructions computer executable instructions cause a computer processor to perform the steps of comparing and analyzing the one or more user interface elements further comprises:
calculating a deviation score for each of the one or more user interface elements based on the one or more standards, wherein the deviation score is used to generate the one or more remediation estimations.

11. The computer program product of claim 8, wherein the computer executable instructions computer executable instructions cause a computer processor to perform the steps of:
monitoring one or more software development projects, via one or more machine learning models;
collecting data associated with the one or more software development projects;
generating one or more time estimations associated with development of one or more user interface features associated with the one or more software development projects, wherein the one or more user interface elements are similar to the one or more user interface features; and
generating the one or more remediation estimations based on the one or more time estimations.

12. The computer program product of claim 8, wherein the one or more remediation estimations are generated based on user input.

13. The computer program product of claim 8, wherein the one or more remediation estimations are generated based on accessing records associated with users from a project tracking application.

14. The computer program product of claim 8, wherein the computer executable instructions computer executable instructions cause a computer processor to perform the steps of:
constantly scanning the one or more software applications to determine one or more updates to the one or more software applications; and
generating a new set of remediation estimations associated with the one or more updates.

15. A computer implemented method for performing analysis and generating remediation estimations for user interfaces associated with software applications, the method comprising: crawling one or more software applications associated with an entity;
identifying one or more user interface elements associated with the one or more software applications;
comparing and analyzing the one or more user interface elements with one or more standards stored in a data repository; and
generating one or more remediation estimations associated with modifying the one or more user interface elements to meet the one or more standards based on comparing and analyzing the one or more user interface elements with the one or more standards.

16. The computer implemented method of claim 15, wherein the method of crawling the one or more software applications is initiated in response to:
receiving a new alteration from an entity system, wherein the one or more standards comprise new alteration standards associated with the new alteration.

17. The computer implemented method of claim 15, wherein comparing and analyzing the one or more user interface elements further comprises:
calculating a deviation score for each of the one or more user interface elements based on the one or more standards, wherein the deviation score is used to generate the one or more remediation estimations.

18. The computer implemented method of claim 15, wherein the method further comprises:
monitoring one or more software development projects, via one or more machine learning models;
collecting data associated with the one or more software development projects;
generating one or more time estimations associated with development of one or more user interface features associated with the one or more software development projects, wherein the one or more user interface elements are similar to the one or more user interface features; and
generating the one or more remediation estimations based on the one or more time estimations.

19. The computer implemented method of claim 15, wherein the one or more remediation estimations are generated based on user input.

20. The computer implemented method of claim 15, wherein the one or more remediation estimations are generated based on accessing records associated with users from a project tracking application.
